(19) United States
(12) Patent Application Publication
(10) Pub. No.: US 2026/0023633 A1
(43) Pub. Date: Jan. 22, 2026

(54) TEMPORAL TRANSFORMER-BASED APP TRAFFIC EVENT CLASSIFIER FAILURE DETECTION

(71) Applicant: Netskope, Inc., Santa Clara, CA (US)

(72) Inventors: Kaukab Enayet Syed, Bangalore (IN); Ari Azarafrooz, Rancho Santa Margarita, CA (US); Durgamadhav Behera, Bangalore (IN); Laxman Eluri, Bangalore (IN); Rahul Mohandas, Bangalore (IN)

(73) Assignee: Netskope, Inc., Santa Clara, CA (US)

(21) Appl. No.: 18/780,236

(22) Filed: Jul. 22, 2024

(51) Int. Cl. G06F 11/07

(52) U.S. Cl. CPC G06F 11/0784; G06F 11/0754; G06F 11/0793

(57) ABSTRACT

A data exfiltration protection system that uses machine learning to analyze traffic between multiple end-user devices and multiple vendors. The data exfiltration protection system consists of a tenant using a vendor's application and an app connector transmitting traffic at an application layer of a cloud network. The data exfiltration protection system further consists of a machine learning module that monitors traffic for an event at the app connector and an alert generator. The machine learning module monitors traffic for the event at the application for a period, generates expected traffic behavior using historical logs, and generates forecasted traffic for the event for different periods of time in the future. The machine learning module further determines a difference between monitored traffic and forecasted traffic and flags the event as an anomalous dip when the difference is below a threshold. Finally, the alert generator notifies the tenant about remediation flags.

### BACKGROUND

This disclosure relates, in general, to internet security and data protection systems and, not by way of limitation, to the classification of failure in the detection of traffic events, among other things.

An application event traffic classifier for a cloud system is a predominant component in managing and directing data flow efficiently within the digital infrastructure. In the event of a failure in traffic classification, the consequences can be significant. Misclassified traffic may lead to inefficient resource allocation, where some applications do not receive bandwidth and latency-sensitive traffic is not prioritized, resulting in poor user experience and potential service disruptions. Moreover, security protocols may be compromised if malicious traffic is not correctly identified and isolated, posing a risk to the entire cloud ecosystem.

Furthermore, failure in traffic classification can impede the effectiveness of load balancing, leading to the potential overloading of particular nodes while others remain underutilized. This imbalance can cause increased response times and even system outages, which are detrimental to both service providers and end-users. In a cloud environment where multiple services and applications are interdependent, such disruptions can have a cascading affect with detriment to a wide range of processes and stakeholders.

### SUMMARY

In one embodiment, the present disclosure provides a data exfiltration protection system that uses machine learning to analyze traffic between multiple end-user devices and multiple vendors. The data exfiltration protection system consists of a tenant using a vendor's application and an app connector transmitting traffic at an application layer of a cloud network. The data exfiltration protection system further consists of a machine learning module that monitors traffic for an event at the app connector and an alert generator. The machine learning module monitors traffic for the event at the application for a period, generates expected traffic behavior using historical logs, and generates a forecasted traffic for the event for different periods of time in future. The machine learning module further determines a difference between a monitored traffic and the forecasted traffic, flags the event as an anomalous dip when the difference is below a threshold. Finally, the alert generator notifies the tenant about remediation flags.

In an embodiment, a data exfiltration protection system that uses machine learning to analyze traffic between multiple end-user devices and multiple vendors. The data exfiltration protection system consists of a tenant using a vendor's application and an app connector transmitting traffic at an application layer of a cloud network. The data exfiltration protection system further consists of a machine learning module that monitors traffic for an event at the app connector and an alert generator. The machine learning module monitors traffic for the event at the application for a period, generates expected traffic behavior using historical logs and generates a forecasted traffic for the event for different periods of time in future. The machine learning module uses multiple variables for training and improving accuracy. The machine learning module further determines a difference between a monitored traffic and the forecasted traffic, flags the event as an anomalous dip when the difference is below a threshold. The anomalous dip is a result of failure in the app connector and the traffic at the app connector is split into different timeframes to reduce detection time. Furthermore, for applications that are interrelated, traffic from a first application is correlated with traffic from a second application to detect a similar anomaly. Finally, the alert generator notifies the tenant about remediation flags.

In an embodiment, a data exfiltration protection method that uses machine learning to analyze traffic between multiple end-user devices and multiple vendors. In one step the data exfiltration protection method includes a tenant using a vendor's application and an app connector transmitting traffic at an application layer of a cloud network. The data exfiltration protection method further includes a machine learning module for monitoring traffic for an event at the app connector and an alert generator. The machine learning module monitors traffic for the event at the application for a period, generates expected traffic behavior using historical logs and generates a forecasted traffic for the event for different periods of time in future. The machine learning module uses multiple variables for training and improving accuracy. The machine learning module further determines a difference between a monitored traffic and the forecasted traffic, flags the event as an anomalous dip when the difference is below a threshold. The anomalous dip is a result of failure in the app connector and the traffic at the app connector is split into different timeframes to reduce detection time. Furthermore, for applications that are interrelated, traffic from a first application is correlated with traffic from a second application to detect a similar anomaly. Finally, the alert generator is used for notifying the tenant about remediation flags.

In yet another embodiment, a computer-readable media is discussed having computer-executable instructions embodied thereon that when executed by one or more processors, facilitate a data exfiltration protection method that uses machine learning to analyze traffic between multiple end-user devices and multiple vendors. In one step the data exfiltration protection method includes a tenant using a vendor's application and an app connector transmitting traffic at an application layer of a cloud network. The data exfiltration protection method further includes a machine learning module for monitoring traffic for an event at the app connector and an alert generator. The machine learning module monitors traffic for the event at the application for a period, generates expected traffic behavior using historical logs and generates a forecasted traffic for the event for different periods of time in future. The machine learning module uses multiple variables for training and improving accuracy. The machine learning module further determines a difference between a monitored traffic and the forecasted traffic, flags the event as an anomalous dip when the difference is below a threshold. The anomalous dip is a result of failure in the app connector and the traffic at the app connector is split into different timeframes to reduce detection time. Furthermore, for applications that are interrelated, traffic from a first application is correlated with traffic from a second application to detect a similar anomaly. Finally, the alert generator is used for notifying the tenant about remediation flags.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIGS. 1A-1B illustrates a block diagram of an embodiment of a data exfiltration protection system with an app connector in a cloud-based network;

FIG. 2 illustrates a block diagram of different components of the data exfiltration protection system;

FIG. 3 illustrates the importance of different static variables and encoder variables of a machine learning module;

FIG. 4 illustrates the importance of different decoder variables of the machine learning module;

FIG. 5 illustrates a block diagram of an embodiment of a cloud open systems interconnection (OSI) model;

FIG. 6 illustrates a graph for counting the anomalous dips via the data exfiltration protection system;

FIG. 7 illustrates a graph representing the detection of an anomalous dip and smooth flow of data at the app connector via the data exfiltration protection system; FIG. 8 illustrates a graph representing the generation of an alert at the data exfiltration protection system;

FIG. 9 illustrates a data exfiltration protection method that uses machine learning to analyze traffic at the app connector;

FIG. 10 illustrates a working mechanism of the machine learning module at an application layer of the cloud OSI model; and

FIG. 11 illustrates a method of correlating traffic of different applications to detect a similar anomaly.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

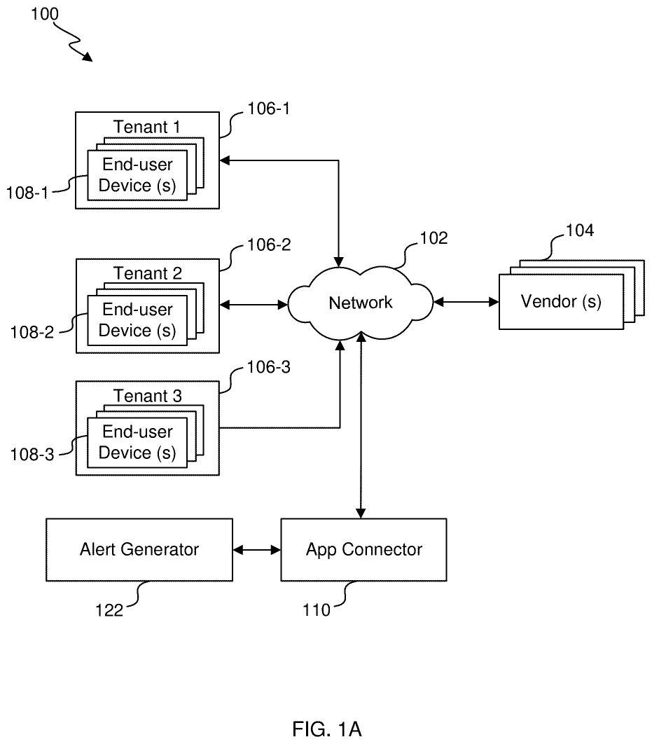

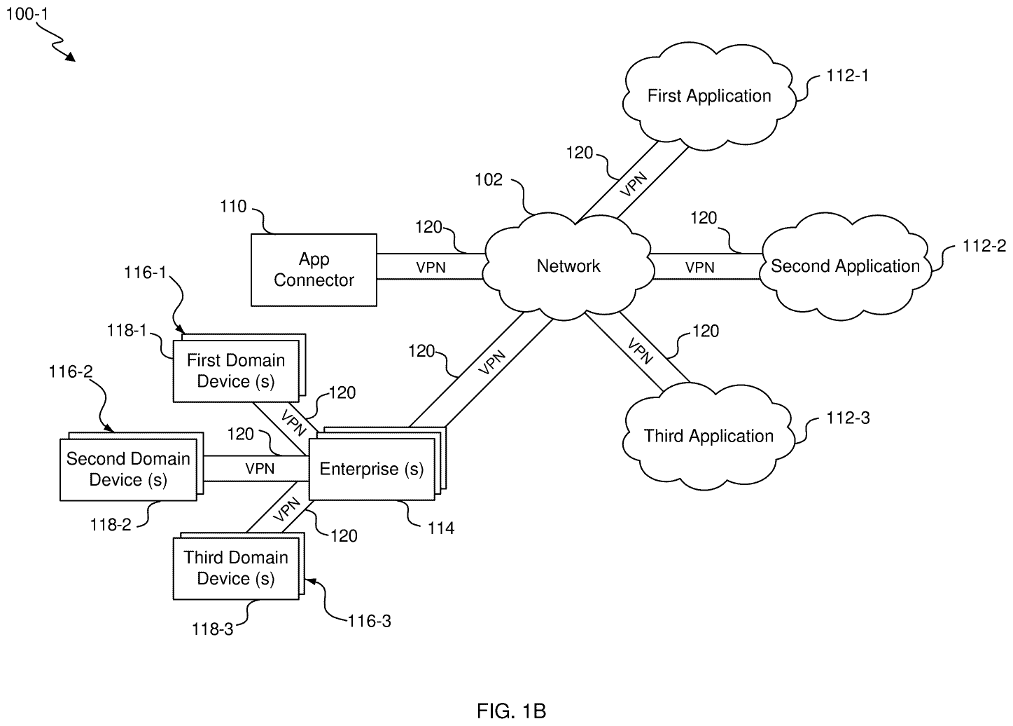

Referring to FIG. 1A, a block diagram of an embodiment of a data exfiltration protection system 100 with an app connector 110 in a cloud-based network is shown. Cloud access security broker (CASB) products are responsible for analyzing the traffic between users and the Software as a Service (SaaS) apps and enforcing data protection controls based on the policies defined. SaaS app vendors such as Google and Microsoft continuously upgrade their existing software for functionality and performance. There is a risk of these SaaS app changes going unnoticed and can have an impact on customer-defined policies resulting in data theft or exfiltration scenarios. Frequent version changes in various applications, such as Google Drive and AWS Lambda, often disrupt the current methods used for event detection of our App Connectors based on network traffic headers. Examples of affected events include AWS Lambda's “Create” event and Google Drive's “Download” event. These event detection failures often go unnoticed unless users report discrepancies in their expected event counts. Moreover, users may not perpetually be aware of which events are being missed, nor is it expected that they should inform us of these issues. There is a need to detect these app changes proactively and mitigate the impact on the users.

The data exfiltration protection system 100 detects any failure in the classification of an event or activity at the application traffic. The data exfiltration protection system 100 includes a network 102, vendors 104, tenant(s) 106 (106-1, 106-2, 106-3), end-user device(s) 108 (108-1, 108-2, 108-3), the app connector 110, and an alert generator 122. The network 102 is any Internet network connecting the tenants 106, the app connector 110, and the vendors 104. Software as a Service works through a cloud delivery model. The vendors 104 commonly host applications and data on their own servers and databases or utilize the servers of a third-party cloud provider. The vendors 104 provide software solutions that are local applications, or software-as-a-service (SaaS) applications which are hosted and maintained by third-party vendors/cloud providers and provided to the end-user devices 108 over the network 102, such as the Internet. The applications can also be hosted within the data center of an enterprise. The end-user device 108 uses content and processing for content sites, for example, websites, streaming content, etc.

The tenant 106 links with multiple end-user devices that access the applications provided by the vendors 104. The end-user devices 108, including a cloud application or subscription that is owned or accessible to the user and other physical devices, such as smartphones, tablets, personal computers (PCs), and many other computers, communicate with the applications of the vendors 104 using the network 102. The end-user devices 108 runs on any operating system (OS) such as Windows™, iOS™, Android™, Linux, set-top box OSes, and Chromebook™. The app connector 110 serves as a bridge between different applications, systems, or services, enabling them to communicate and work together seamlessly over the network 102. By using the app connectors 110, companies can avoid the time-consuming and complex process of creating custom integrations for each new application they use. Instead, the app connectors 110 provide a standardized way to link systems at an application layer of a cloud open systems interconnection (OSI) model, ensuring that data is synchronized and up-to-date across the entire organization.

Regulating and analyzing traffic on the app connectors 110 is imperative for managing network performance and security. The app connectors 110 allow administrators to specify which applications should be accessible over their network, ensuring that traffic for those applications is securely managed. Analyzing traffic involves monitoring and examining the data passing through the app connectors 110 to identify patterns, detect anomalies, and troubleshoot issues. This provides insights into bandwidth usage, identifies potential bottlenecks, and helps optimize network resources. The data exfiltration protection system 100 employs the app connectors 110 to offer real-time visibility into network bandwidth and performance, aiding in the identification of app-events and monitoring interface traffic. The data exfiltration protection system 100 uses machine learning and detects anomalous dip in the app-events at the app connector 110 to ensure the safety of traffic across the network 102.

The alert generator 122 sends an alert for investigating a flag. The alert is only generated if the flagged event/activity persists for several days. In such a case, the anomalous dip in the app-events at the app connector 110 is investigated and the issue is mitigated by the vendors 104.

Referring next to FIG. 1B, a block diagram of an embodiment of data exfiltration protection system 100-1 is shown. The data exfiltration protection system 100-1 allows multiple tenants in different domains to communicate with applications of various cloud providers over the network 102. The data exfiltration protection system 100 allows multiple tenants/multi-tenant systems or enterprises 114 to use the same network separated by a domain or some other logical separation. Encryption, leased/encrypted tunnels, firewalls, and/or gateways can keep the data from one enterprise 114 separate from the other enterprise 114. The app connector 110 assists with the smooth flow of traffic for individual domain data centers.

The data exfiltration protection system 100-1 may include a first computing environment 116-1 having end-user devices for a first domain 118-1, a second computing environment 116-2 having end-user devices for a second domain 118-2, and a third computing environment 116-3 having end-user devices for a third domain 118-3. Individual domain communicates with the enterprise 114 using a virtual private network (VPN) 120 over local area networks (LANs), wide area networks (WANs), and/or the network 102. Instead of the VPN 120 as an end-to-end path, tunneling (e.g., Internet Protocol in Internet Protocol (IP-in-IP), Generic Routing Encapsulation (GRE)), policy-based routing (PBR), Border Gateway Protocol (BGP)/Interior Gateway Protocol (IGP) route injection, or proxies could be used.

Enterprises 114 are connected to the app connector 110 using the VPN 120 over the network 102. Some examples of the applications 112 include Office 365®, Box™, Zoom™, and Salesforce™ etc. The user subscribes to a set of services offered by the Cloud Application Providers or the vendors 104. Some or all of the vendors 104 may be different from each other, for example, a first application 112-1 may run Amazon Web Services (AWS)®, a second application 112-2 may run Google Cloud Platform (GCP)®, and the third application 112-3 may run Microsoft Azure®. Although three different applications are shown, any suitable number of applications may be provided that might be strictly captive to a particular enterprise or otherwise not accessible to multiple domains.

Each of the applications 112 may communicate with the network 102 using a secure connection. For example, the first application 112-1 may communicate with the network 102 via the VPN 120, the second application 112-2 may communicate with the network 102 via a different VPN, and the third application 112-3 may communicate with the network 102 via yet another VPN. Some embodiments could use leased connections or physically separated connections to segregate traffic. Although one VPN is shown, many VPNs exist to support different end-user devices, tenants, domains, etc.

Enterprises 114 may also communicate with the network 102 and the end-user device(s) 108 for their domain via VPNs 120. Some examples of the enterprises 114 may include corporations, educational facilities, governmental entities, and private consumers. Each enterprise may support multiple domains to separate its networks logically. The end-user device(s) 108 for each domain may include computers, tablets, servers, handhelds, and network infrastructure authorized to access the computing resources of their respective enterprises.

Further, the app connector 110 may communicate with the network 102 via the VPN 120. Communication between the app connector 110, the end-user device(s) 108, and the vendors 104 (cloud application providers) for a given enterprise 114 can be either a VPN connection or tunnel depending on the preference of the enterprise 114.

The data exfiltration protection system 100 analyzes traffic at the app connector 110 using a machine learning algorithm to automatically identify anomalous dips in event counts for the application 112. The data exfiltration protection system 100 not only enables the carly detection of irregularities in traffic patterns but is also easy to deploy and maintain. The significance of the data exfiltration protection system 100 lies in its ability to reduce user incidents proactively. By algorithmically identifying anomalies in an application's event count, developers of the applications 112 are alerted to adjust the existing event detection mechanisms, often before users even notice an issue.

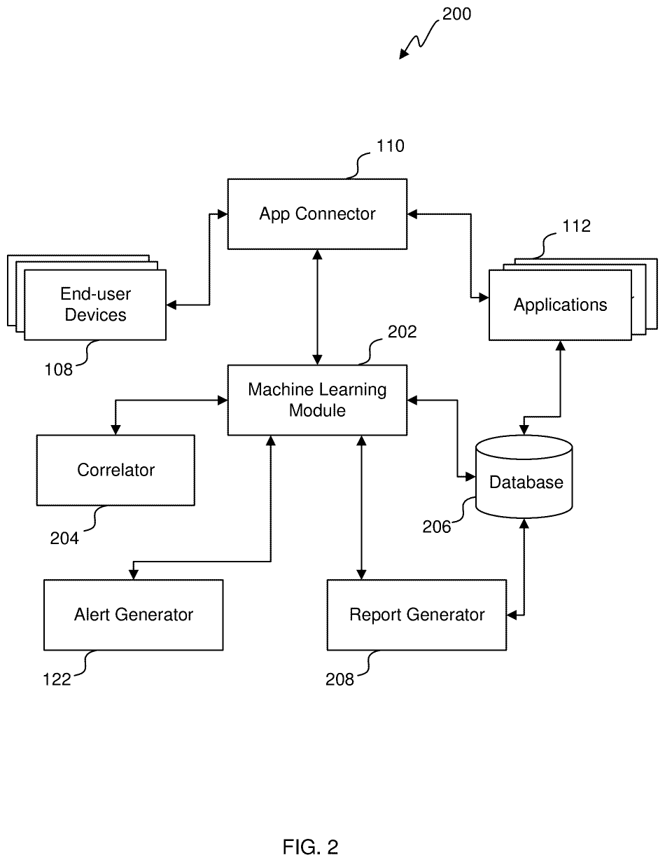

Referring next to FIG. 2, a block diagram of components 200 of the data exfiltration protection system 100 is shown. The components 200 of the data exfiltration protection system 100 include the end-user device(s) 108 communicating with the applications 112 via the app connector 110. The components 200 further include a machine learning module 202, a correlator 204, a database 206, an alert generator 122, and a report generator 208. The data exfiltration protection system 100 may include other components that are not shown in FIG. 2. Traditionally, anomaly detection for web traffic data has used various Univariate Time series models which are difficult to maintain because one needs to maintain different models for each time series. Further, these univariate time series modeling approaches such as Seasonal Autoregressive Integrated Moving Average (SARIMA), Long Short-Term Memory (LSTM), or Tree-based methods do not account for interaction effects between different time series. Multivariate Autoregression style models are also present to model multivariate time series, but these models want a lot of data to converge in the training phase.

The machine learning module 202 uses a single model based on Transformer architecture or a pre-trained time series foundation model such as, TimeGPT, to monitor traffic and to detect the anomalous dip in network traffic at app-event level. In one embodiment, a Temporal Fusion transformer (TFT) model has been trained for this task. It is a flavor of transformer that provides not only multi-horizon, multivariate forecasting but also provides interpretability about the model and the generated forecast. The model level interpretability provides an explanation of which variables help in improving accuracy, such as Holiday flag, lag magnitude, etc. Multivariate forecasting helps us in generating the expected traffic behavior for each app-event from the single model, while the multi-horizon feature helps in generating expected traffic for multiple periods of time in the future. The expected traffic behavior is built using historical logs. To identify an event as an anomalous dip observed traffic count is compared with the forecasted traffic count and if the difference is below a particular threshold the event is marked as an anomalous dip that should be investigated. The weights of TFT model parameters get refreshed periodically in 28 days to keep the model in sync with the changing dynamics of new customers and customer churn.

Based on the outcome whether the alert generated is valid or not a precision of 70% is observed which is significant considering the nature of the network-traffic pattern. The TFT model has helped keep the traffic-event detector in good health, with very rare false negatives (˜2 False Negatives in a month while generating approximately 40 alerts in a month). The investigators now know which app needs to be investigated to find whether their events are getting detected or not.

The machine learning module 202 has multiple features including multivariate time series, external events, lag features etc. Each app-event combination has its own time series and thus these different time series of different app-event combinations are called multivariate time-series. For example, the download event of the app google-drive has its own time series for event count and the download event of one-drive has its own time series and so on. For external events currently the model uses the US Holiday calendar to make the forecast. Other holidays and variables can be added to the model in future. The lag features states that the model requires that at least 6 months of historical data is present for each of the app-event time series.

In another embodiment, a pre-trained time series foundation model-TimeGPT, is used for forecasting and anomaly detection at the machine learning module 202. The TimeGPT model helps in increasing the coverage of app-activities processed by the app connector 110 by decreasing the time span of lag features from 6 months to 1-5 months. The TimeGPT model is not based on any existing large language model (LLM) but is independently trained on vast timeseries dataset as large transformer model and is designed to minimize the forecasting error. The architecture of the TimeGPT model consists of an encoder-decoder structure with multiple layers, each with residual connections and layer normalization. Finally, a linear layer maps the decoder's output to the forecasting window dimension. TimeGPT model when used as the machine learning module 202 provides zero-shot inference, fine tuning, API access, multiple series forecasting, cross validation, and handling irregular timestamps. Furthermore, the organizations can add custom loss functions to tailor the fine-tuning process and can incorporate additional variables that might influence the predictions to enhance forecast accuracy by the app connector 110.

This means that temporal fusion transformer model is used for all the app-activities that have more than 6 months of historic data for training. On the other hand, the TimeGPT model is a pre-trained foundation time series model that is used to detect the anomaly for the app-activities that have 1-5 months of historic data. In this application, anomaly detection at the app connector 110 is described using the temporal fusion model. Similar methods and components can be used for a TimeGPT based anomaly detection system.

The correlator 204 matches the traffic patterns of multiple applications. This helps in detecting the anomalous dip at the second application 112-2 that is related to the first application 112-1. For example, traffic from Microsoft Word is generally related to Google Drive. So, if Word gets an update and the app connector 110 fails to regulate the traffic post-update, it will cause a dip in the app activity. Since activities at Word are related to those at Google Drive, the correlator 204 would analyze those activities. If the traffic from both applications is correlated, the dip in Google drive will be detected even before it has occurred. The machine learning module 202 uses data from the correlator 204 to make predictions for the second application 112-2 that is related to the first application 112-1.

The database 206 keeps records of the anomalous dips detected, the flags raised, and the alerts generated. The database 206 also stores the false positives and false negatives generated by the data exfiltration protection system 100. Furthermore, the database 206 also stores the training data or the historical logs as the machine learning module 202 is trained on the data of last six months. The database 206 can also keep record of the detection time of valid alerts. The alert generator 122 sends an alert for investigating a flag. The alert is only generated if the flagged event/activity persists for several days. In such case, the anomalous dip in the app events at the app connector 110 is investigated and the issue is mitigated manually by a testing team of the organization. In some scenarios, the organization or the testing team of the organization can reach out to the vendors 104 if the application 112 itself has a bug that makes it unable to carry out the intended task.

The report generator 208 creates a report after the detection of the anomalous dip in the app activity and sends it to the concerned authority. In one embodiment, report generator 208 sends a daily email report containing several sections. The two important sections focus on recent high-likelihood anomalies and old anomalies. The recent high-likelihood anomalies are the anomalies that are upcoming and have been noticed for some days. The dip score is an important column to consider here, as the higher the dip counts on the negative side, the higher the probability of the alert being valid. Whereas the old anomalies re-affirms that these anomalies were detected in the past. Some exemplary key columns in the report and their interpretation are given below:
1. dip_score: tells how many dips have been observed. Thus, a higher absolute value indicates a strong chance of a dip.
2. score2: tells based on the day of week how likely this observed count is based on historical data. The lower the value-the higher the chance of anomaly.
3. pct_95: tells what the 95th percentile value was in training data, for reference purposes. So that one can decide whether this is a high-impact application or not.
4. impact_count: this is averaged & clamped “count per day” missing in the data for the app-event. This again tells how big of app-event is.

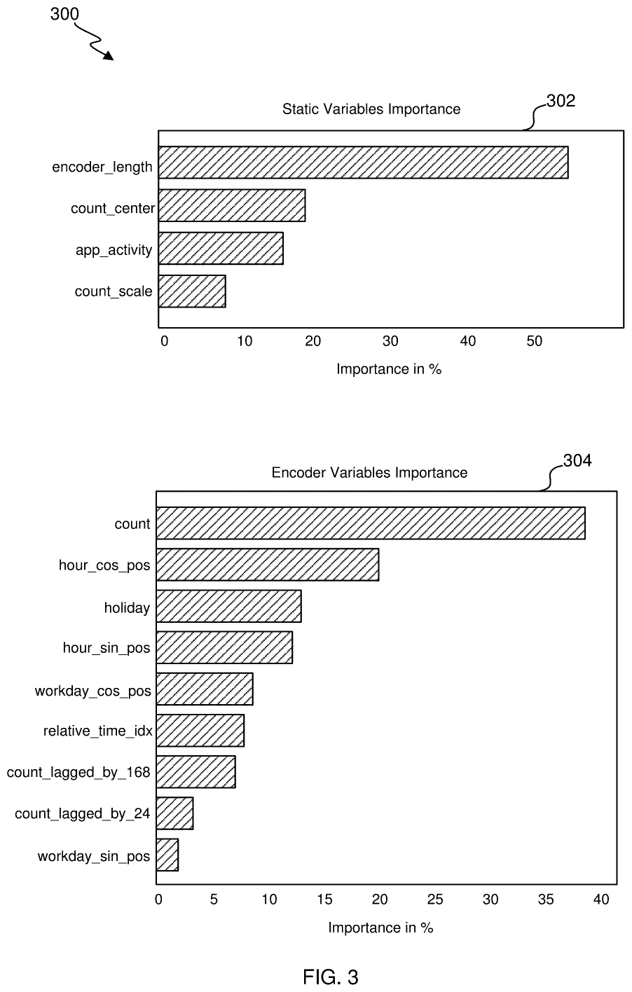

Referring next to FIG. 3, bar graphs 300 indicating the importance of different static variables 302 and encoder variables 304 of machine learning module 202 are shown. The machine learning module 202 uses different variables, each of them carrying a different weight. Adding or reducing the variables affects the performance of machine learning module 202. The dips in event count are to be detected at measurement period (mp) event level, and the data in the current algorithm is clubbed every 8 hours. Thus, there are 3 data points (7 AM, 3 PM, & 11 PM) per day for specific app-event per mp. Sample data along with features are shown in the table below:

Sample every app-event per mp data along with features:

| | mp | app | activity | year | count | timestamp | time_idx | Next_timestamp |
|---|---|---|---|---|---|---|---|---|
| 0 | am2 | AWS | Create | 2022 | 0.0 | 2022-07-01 | 0 | 1.0 |
| | | Lambda | | | | 07:00:00 | | |
| 1 | am2 | AWS | Create | 2022 | 3.0 | 2022-07-01 | 1 | 2.0 |
| | | Lambda | | | | 15:00:00 | | |
| 2 | am2 | AWS | Create | 2022 | 0.0 | 2022-07-01 | 2 | 3.0 |
| | | Lambda | | | | 23:00:00 | | |
| 3 | am2 | AWS | Create | 2022 | 1.0 | 2022-07-02 | 3 | 4.0 |
| | | Lambda | | | | 07:00:00 | | |
| 4 | am2 | AWS | Create | 2022 | 0.0 | 2022-07-02 | 4 | 5.0 |
| | | Lambda | | | | 15:00:00 | | |

The machine learning module 202 uses 181+14 days of historical data for each app-activity count in each mps, for training and validation of the model. Thus, reducing the data requirement from 1 year to 6 months of data. PyTorch provides an implementation of Temporal fusion transformer, a flavor of transformer that provides not only multi-horizon, multi-variate forecasting but also the interpretation that it learns with its multi-head attention during training phase, while minimizing the loss function to learn the forecasting parameters.

The holiday's package is used to create a new variable “holiday”. Thus, a day is classified either as a Holiday or Holiday-adjacent, or a normal-day. And this variable is marked by the TFT as one of the important variables. TFT model also takes the app-activity & mp name as the static variable 302. The model interpretation says that the static variable 302 mp hardly matters. Other variables include transformation of week of day and hour of day fields:

$$\begin{matrix}a . workday\_sin \_pos = np . sin ( weekday of date / 7 * 2 * np . pi ) \\ b . workday\_cos \_pos = np . cos ( weekday of date / 7 * 2 * np . pi ) \\ c . hour\_sin \_pos = np . sin ( hour / 24 * 2 * np . pi ) \\ d . hour\_cos \_pos = np . cos ( hour / 24 * 2 * np . pi )\end{matrix}$$

Further, as explained earlier, the data granularity has been changed to 8 hours as the method of identifying valid dip has been discretized from a continuous process i.e. taking an average over 7 days. Now dip counts are made irrespective of the magnitude of the dip, thus not giving importance to a single data point to decide. Discretization also helped in reducing the detection time as we no longer have to wait for an average of 7 days to flag a dip. Both the static variables 302 and the encoder variables 304 graphs show the corresponding variables on the vertical axis and their importance on the horizontal axis. As stated earlier, the static variables 302 don't have much influence on the machine learning module 202. The encoder length is set to 214 and it carries substantial importance among the static variables 302.

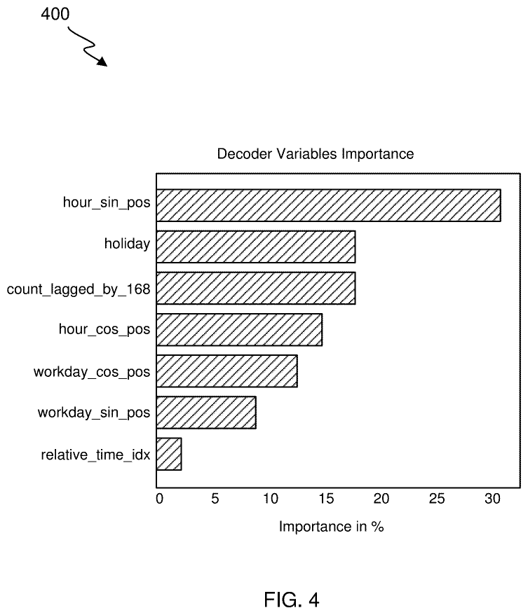

Referring next to FIG. 4, the importance of different decoder variables 400 of the machine learning module 202 is shown. The decoder variables 400 along with the encoder variables 304 and the static variables 302 help in making a prediction. The predication provides the attention weights for different part of time series. However, holidays are the key predictors in the TFT model of machine learning module 202. For the decoder variables 400, the transformation of workday into hours holds the top importance. The finalized values for tuning parameters of the TFT model are shown in Table II:

TABLE II
Finalized values for Tuning Parameters

| | |
|---|---|
| 1. | Pytorch_forecasting |
| 2. | Models |
| 3. | Temporal_fusion_transformer |
| | 1. TemporalFusionTransformer |
| 4. | target=“count” |
| 5. | group_ids=[“mp”, “app_activity”] |
| 6. | static_categoricals=[“mp”, “app_activity”] |
| 7. | static_reals=[ ] |
| 8. | time_varying_known_categoricals=[“holiday”] |
| 9. | time_varying_unknown_categoricals=[ ] |
| 10. | time_varying_unknown_reals=[“count”,] |
| 11. | Hidden_size = 128 |
| 12. | LSTM layers = 1 #(to learn both long-and short-term |
| | temporal relationships from both |
| | observed and known time) |
| 13. | max_encoder_length = 214 |
| 14. | attention_head_size = 1 #(long-term dependencies |
| | are captured using a novel interpretable |
| | multi-head attention) |
| 15. | max_prediction_length = 84 #(Decoder Length) |

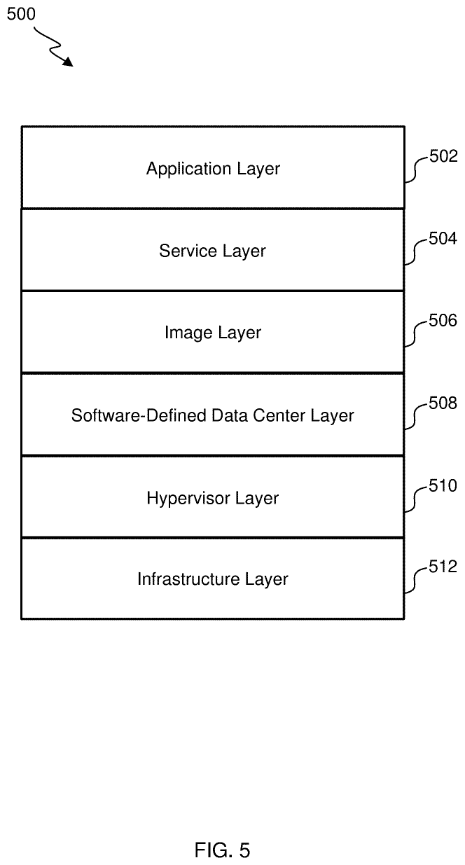

Referring next to FIG. 5, a block diagram of an embodiment of a cloud OSI model 500 is shown. The cloud OSI model 500 for cloud computing environments partitions the flow of data in a communication system into six layers of abstraction. The cloud OSI model 500 for cloud computing environments can include, in order: an application layer 502, a service layer 504, an image layer 506, a software-defined data center layer 508, a hypervisor layer 510, and an infrastructure layer 512. The respective layer serves a class of functionality to the layer above it and is served by the layer below it. Classes of functionality can be realized in software by various communication protocols.

The infrastructure layer 512 can include hardware, such as physical devices in a data center, that provides the foundation for the rest of the layers. The infrastructure layer 512 can transmit and receive unstructured raw data between a device and a physical transmission medium. For example, the infrastructure layer 512 can convert the digital bits into electrical, radio, or optical signals.

The hypervisor layer 510 can perform virtualization, which can permit the physical devices to be divided into virtual machines that can be bin-packed onto physical machines for greater efficiency. The hypervisor layer 510 can provide virtualized computing, storage, and networking. For example, OpenStack® software that is installed on bare metal servers in a data center can provide virtualization cloud capabilities. The OpenStack® software can provide various infrastructure management capabilities to cloud operators and administrators and can utilize the Infrastructure-as-Code concept for deployment and lifecycle management of a cloud data center. In the Infrastructure-as-Code concept, the infrastructure elements are described in definition files. Changes in the files are reflected in the configuration of data center hosts and cloud services.

The software-defined data center layer 508 can provide resource pooling, usage tracking, and governance on top of the hypervisor layer 510. The software-defined data center layer 508 can enable the creation of virtualization for the Infrastructure-as-Code concept by using representational state transfer (REST) application programming interfaces (APIs). The management of block storage devices can be virtualized, and users can be provided with a self-service API to request and consume those resources which do not entail any knowledge of where the storage is deployed or on what type of device. Various compute nodes can be balanced for storage.

The image layer 506 can use various operating systems and other pre-installed software components. Patch management can be used to identify, acquire, install, and verify patches for products and systems. Patches can be used to rectify security and functionality problems in software. Patches can also be used to add new features to operating systems, including security capabilities. The image layer 506 can focus on the computing in place of storage and networking. The instances within the cloud computing environments can be provided at the image layer 506.

The service layer 504 can provide middleware, such as functional components that applications use in tiers. In some examples, the middleware components can include databases, load balancers, web servers, message queues, email services, or other notification methods. The middleware components can be defined at the service layer 504 on top of specific images from the image layer 506. Different cloud computing environment providers can have different middleware components. The application layer 502 can interact with software applications that implement a communicating component. The application layer 502 is the layer that is closest to the user. Functions of the application layer 502 can include identifying communication partners, determining resource availability, and synchronizing communications. Applications within the application layer 502 can include custom code that makes use of middleware defined in the service layer 504.

Various features discussed above can be performed at multiple layers of the cloud OSI model 500 for cloud computing environments. For example, translating the general policies into specific policies for different cloud computing environments can be performed at the service layer 504 and the software-defined data center layer 508. Various scripts can be updated across the service layer 504, the image layer 506, and the software-defined data center layer 508. Further, APIs and policies can operate at the software-defined data center layer 508 and the hypervisor layer 510.

Different cloud computing environments can have different service layers 504, image layers 506, software-defined data center layers 508, hypervisor layers 510, and infrastructure layers 512. Further, respective cloud computing environments can have the application layer 502 that can make calls to the specific policies in the service layer 504 and the software-defined data center layer 508. The application layer 502 can have noticeably the same format and operation for respective different cloud computing environments. Accordingly, developers for the application layer 502 do not have to understand the peculiarities of how respective cloud computing environments operate in the other layers.

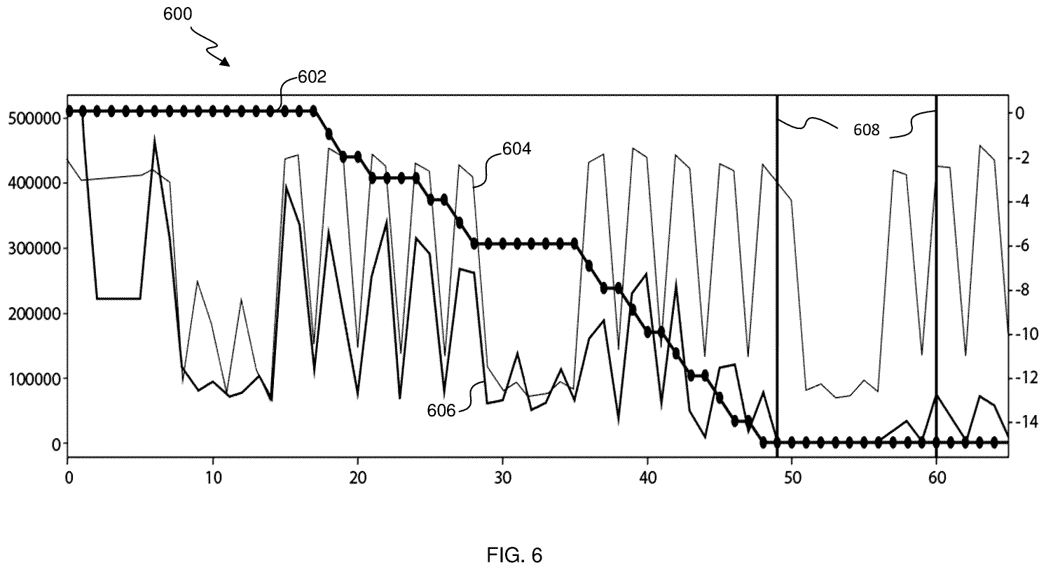

Referring next to FIG. 6, a graph for counting 600 anomalous dips via the data exfiltration protection system 100 is shown. At section 602, the actual app activity per mp is shown. At section 604 and section 606, the predicted or forecasted traffic and the observed traffic at the app connector 110 are shown respectively. It is observed that substantial data show weekly seasonality i.e. today's value is substantially co-related with 7 days ago value and so on. So, a logistic distribution is fit for each day of the week i.e. (Sun, Mon, . . . ) to find the parameters at app-mp-day_of_week level using the following command:
scipy.stats.logistic.fit

Here, logistics is chosen because the higher the value, the less likely it is to be an anomaly that needs to be flagged. Using these parameters, the likelihood of the observed value of the day is calculated, and if the likelihood is above the threshold, we reject that anomaly from being reported.

As detecting the anomalous dip in unsupervised learning, there is no limit to exploring the architecture, and one has to stop at a particular point because a low MAPE/loss-function value does not indicate that machine learning module 202 will be good in detecting dips. So, the TFT model is trained periodically for 28 days on 195 days of data i.e. by using 181 days for training and 14 days for validation purposes. The validation data is helpful for the TFT model to stop early and for making other heuristics during the training process. The TFT model makes daily forecasting say y_hat_t. The model can generate a forecast for a greater number of days but then it will not be based on the most recent data. Once the forecast is generated, it is standardized using training data parameters, and the difference is calculated as:
i. z score=actual_value_standerdized−forecasted_standardized

This difference is then used for detecting the anomalous dip. The difference between the forecasted traffic or app activity and the observed app activity is shown in section 608. Since in the marked time frame of the section 608, the difference (z score) is lesser than a predetermined threshold, the traffic is said to have an anomalous dip. Some guidelines for determining the anomalous dip are given below:
ii. Dip: Observed (z score normalized)-Forecasted (z score normalized)<threshold →count as 1 dip
iii. Dip masked (not counted) if the forecasted value or observed value<minimum_value in training data+1*std_deviation
iv. Dip count with sliding window reset of 3 days*on not finding dip:
a. Thus, self-correction if the levels are back.
b. Dip count>threshold→Send Alert

This means that after a time limit is reached i.e., 3 days and the dip count is still above a particular threshold, then the alert generator 122 sends an alert away from the machine learning module 202.

The TFT model of the machine learning module 202 splits the traffic into different timeframes which helps in faster execution of workflow. The earlier version took 3-4 hours to execute the workflow i.e. to flag anomaly of the day for each mp. Thus, the total runtime was number_of_mps*4 hours. The TFT model workflow executes in less than 30 minutes to flag the anomaly of the day for the total mps in a single run. The refined version of the machine learning module 202 reduces disk space usage. The earlier version will make the disk full of the cluster in Google Cloud, which will lead to manually spinning a new cluster whenever the disk is full. In the TFT model the files, model, and data are transferred via Google Cloud bucket, and without using any disk space. Thus, there has not been a need for any manual intervention in the last 2 months to spin a new computing cluster. Furthermore, the detection time to alert the validity of anomalous dip has been reduced in the TFT model version from 7 days to 3 days or less. The model gets automatically refreshed periodically in 28 days, and this feature was not available in the previous version.

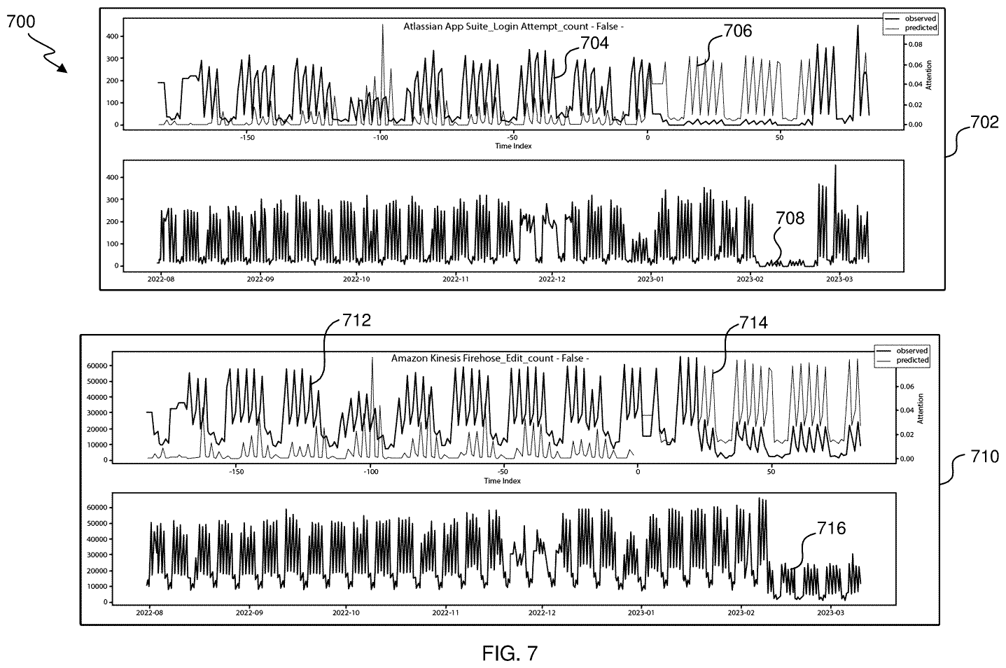

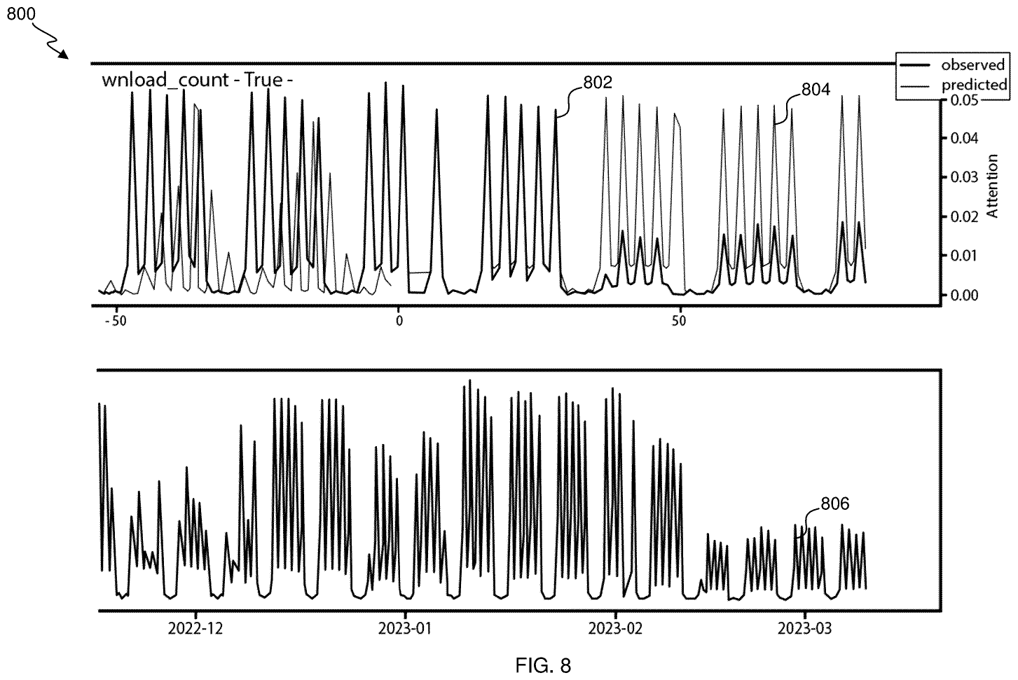

Referring next to FIG. 7, a graph 700 representing detection 702 of an anomalous dip and smooth flow of data 710 at the app connector 110 via the data exfiltration protection system 100 is shown. During the model development phase, the TFT model was compared with the previous performer model in May and June 2023 data. The performer model is a transformer architecture that estimates regular full-rank-attention transformers with provable accuracy. The following accuracy numbers were observed, shown in Table III, and hence the decision for dark-launch was taken.

TABLE III
May 2023 Performer model performance at app-event level:

| validity | # of unique event | % age of event |
|---|---|---|
| Amazon | 6 | 21% |
| NA | 2 | 7% |
| Invalid | 9 | 32% |
| Valid | 11 | 40% |
| Grand Total | 28 | 100.00% |

Overall, the recall is low along with precision being low. Most of the events that are reported to have low magnitude (i.e. 95th percentile value being less than 200). The precision can be said to be around 55% for the performer model if the low-magnitude events are ignored.

TABLE IV
June 2023 TFT model performance at app-event level:

| manual_validity | Dip score == −3 | Dip score < −3 | | Grand Total |
|---|---|---|---|---|
| Amazon | | 7 | (22%) | 7 |
| Invalid | 4 | 3 | (9%) | 7 |
| Valid | 5 | 23 | (69%) | 28 (67%) |

| | | | |
|---|---|---|---|
| Grand Total | 9 | 33 | 42 |

The precision for the TFT model in dark-launch ranges around 67-69% overall for the month of June. Thus, the accuracy lift=(67−55)/55 =21% which is a significant improvement as compared to the previous performer model. The results can also be seen in section 708 where the actual count for login attempts at Atlassian App Suite is shown. At section 704 and 706, the patterns for observed traffic and the predicted traffic are shown respectively. According to the machine learning module 202, no recent changes went in for this activity and the regression suit did not detect any issue. However, the dip seen at the section 708 is the result of an application upgrade done by the user. Since a Login attempt is generated only when the policy is configured, a customer might have updated the policies which resulted in the dip.

Up next, a graph representing a smooth flow of data 710 at the app connector 110 via the data exfiltration protection system 100 is shown. At section 712 and 714, the patterns for observed traffic and the predicted traffic for edit count of the Amazon Kinesis Firehose app are shown respectively. At section 716, the actual traffic pattern of Amazon Kinesis Firehose Edit count is shown. Since it is a P2 app, it is not tested by the machine learning module 202. Furthermore, no changes went in during this period and no bugs were reported as the pattern as sections 714 and 716 align with each other.

Referring next to FIG. 8, a graph representing the generation of an alert 800 at the data exfiltration protection system 100 is shown. At sections 802 and 804, the patterns for observed traffic and the predicted traffic for the download activity of the Salesforce app are shown respectively. At section 806, the actual traffic pattern of download activity at the Salesforce app is shown. Since the actual count at section 806 is way lesser than the predicted count at section 804 and crosses the threshold, the dip is flagged at the app connector 110. If the anomalous dip persists after a time limit i.c., 3 days, then an alert is generated for the traffic at the app connector 110. The alert is then sent for further investigations.

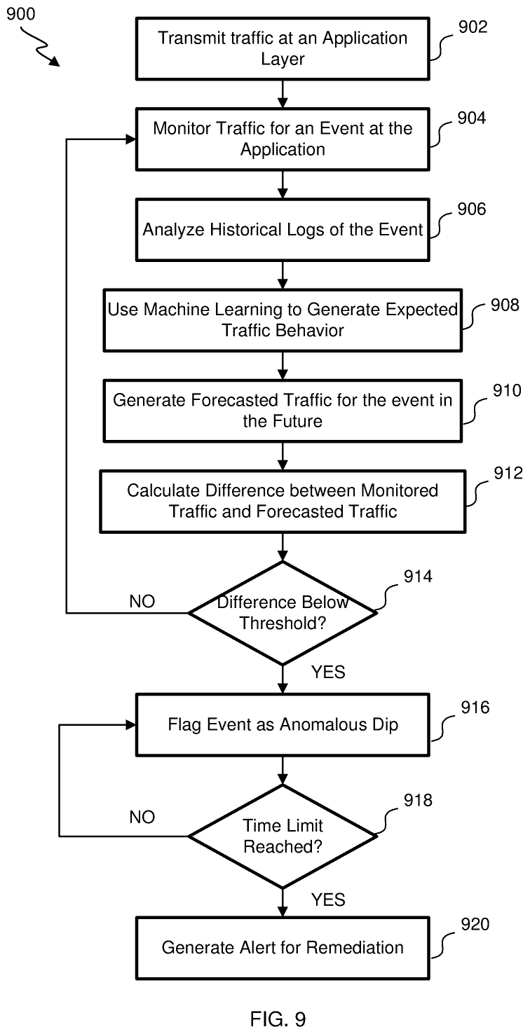

Referring next to FIG. 9, a data exfiltration protection method 900 that uses machine learning to analyze traffic at the app connector 110 is shown. At block 902, the app connector 110 transmits traffic at the application layer 502 of the cloud network. This allows multiple applications to connect with the end-user device(s) 108 without needing separate configurations. The applications 112 are provided by their vendors on the cloud. The traffic from different applications and each app activity is monitored at the app connector 110.

At block 904, the app connector 110 monitors traffic for an event or activity at the application 112. The app-events are monitored so that a failure in the activity of the app connector 110 can be detected before it creates a problem. The users can also provide feedback on the working of the app connector 110 to make the system run efficiently.

At block 906, the machine learning module 202 analyzes historical logs of the event. For this purpose, historical data of the past 181+14 days is used for each app-activity count in each mps, for training and validation of the model. After training and validation, events such as US holidays are taken in for a period of six months.

At block 908, the machine learning module 202 uses the TFT model to generate expected traffic behavior. The expected traffic behavior indicates that a dip in the traffic at the app connector 110 is expected to happen on a holiday or near the holidays. Since the holidays are a part of the training data, the TFT model does not flag them as anomalous dips.

At block 910, forecasted traffic is generated for the events in future. The forecasted traffic predicts the app activity at the app connector 110 around a specific holiday. Once the event happens, the actual traffic for the app activity is also monitored. At block 912, the machine learning module 202 calculates the difference between the monitored traffic (or actual traffic) and the forecasted traffic.

At block 914, the machine learning module 202 checks whether the difference between the actual traffic and the forecasted traffic is above a predetermined threshold. If the difference does not cross the threshold value, the dip is not flagged as anomalous and the app connector 110 keeps on monitoring traffic. Otherwise, if the difference is above a threshold value, then the app activities for that event are flagged as anomalous dip at section 916.

At block 918, the data exfiltration protection system 100 waits for 3-5 days and checks if the dip persists. If the anomalous dip is resolved before the time limit is reached, then there is no need for remediation. On the other hand, if the time limit is reached and the anomalous dip remains unresolved, then the alert generator 122 sends an alert for remediation at block 920. The remediation is done when the anomalous dip triggers a policy for the end-user device(s) 108.

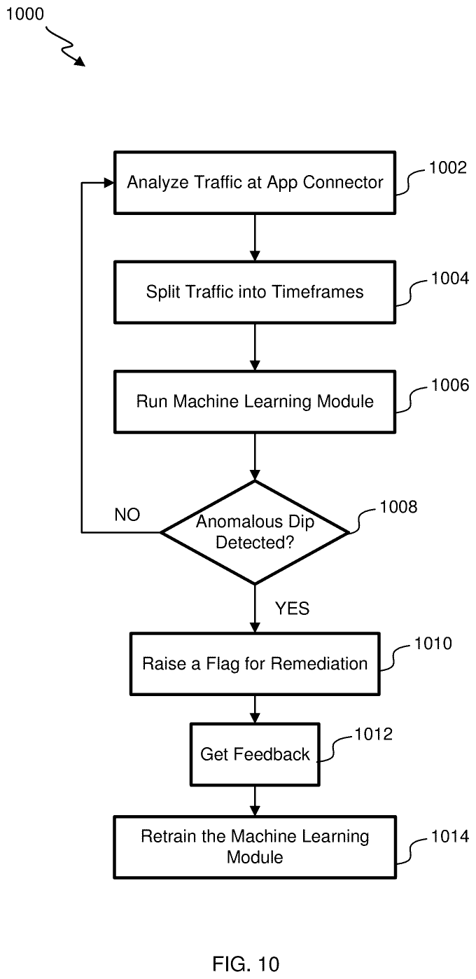

Referring next to FIG. 10, a working mechanism 1000 of the machine learning module 202 at the application layer 502 of the cloud OSI model 500 is shown. At block 1002, the app connector 110 analyzes traffic between the end-user device(s) 108 and the applications 112 at the application layer 502. At block 1004, the traffic is split into timeframes such that traffic of a day is chunked into three frames. This helps in reducing the detection time and managing the app activities at the app connector 110.

At block 1006, the machine learning module 202 is run on the incoming traffic. The machine learning module 202 uses the TFT module to create a forecasted traffic behavior. At block 1008, the machine learning module checks whether an anomalous dip is detected or not. The dip in app activities for an event is said to be anomalous only if the app-count difference between the actual traffic and the forecasted traffic is above a particular threshold.

If the anomalous dip is not detected, the app connector 110 keeps on monitoring the incoming traffic at the application layer 502. Otherwise, if the anomalous dip is detected, then a flag for remediation is raised at block 1010. Note that once the anomalous dip is flagged, the machine learning module 202 waits for 3-5 days before asking for further investigations.

At block 1012, the machine learning module 202 gets feedback from the users. The feedback is meant to improve the working of the machine learning module 202 and to refine the training dataset. At block 1014, the machine learning module 202 is retrained on the new and improved datasets.

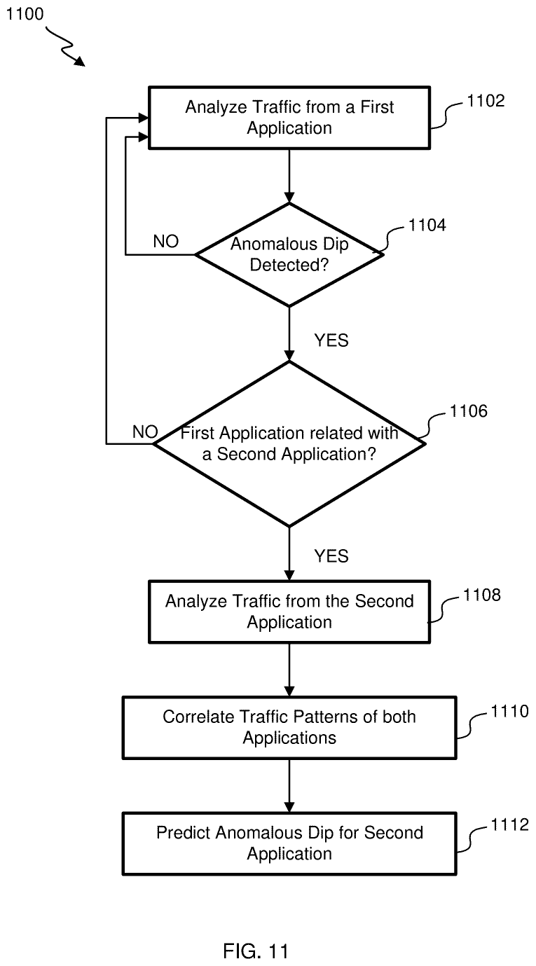

Referring next to FIG. 11, a method of correlating traffic 1100 of different applications to detect a similar anomaly is shown. The method of correlating traffic 1100 helps in detecting a similar anomaly where traffic from multiple applications is interrelated. At block 1102, the app connector 110 analyzes traffic from the first application 112-1. At block 1104, the machine learning module 202 is run on the incoming traffic to detect any anomalous dip. If the anomalous dip is not detected, the app connector 110 keeps on transmitting traffic on the application layer 502.

On the other hand, if the anomalous dip is detected in the traffic related to the app activity of the first application 112-1, the correlator 204 checks if the first application is related to the second application 112-2 at block 1106. If the two applications are not related, the app connector 110 keeps on transmitting traffic on the application layer 502.

Whereas if the first application 112-1 relates to the second application 112-2, the machine leaning module analyzes the traffic from the second application 112-2 at block 1108. At block 1110, the correlator 204 matches the traffic patterns from both applications. This helps in the case where traffic from the first application 112-1; Microsoft Word relates to the second application 112-2; Google Drive. So, if Word gets an update and the app connector 110 fails to regulate the traffic post-update, it will cause a dip in the app activity.

At block 1112, the machine learning module 202 predicts the anomalous dip for the second application 112-2. Since activities at Word are related to those at Google Drive, the correlator 204 will analyze those activities. As a result, the dip at Google Drive will be detected even before it has occurred.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as a limitation on the scope of the disclosure.

1. A data exfiltration protection system that uses machine learning to analyze traffic between a plurality of end-user devices and a plurality of vendors, the data exfiltration protection system comprises:
a tenant of a plurality of tenants using a first application from a vendor of the plurality of vendors, tenant links with the plurality of end-user devices;
an app connector to transmit traffic between the plurality of end-user devices and the plurality of vendors at an application layer of a cloud network;
a machine learning module comprising one or more processors configured to identify an event of the first application at the app connector, the machine learning module is operable to:
monitor traffic for the event at the first application for a period of time;
generate an expected traffic behavior for the event of the first application, wherein the expected traffic behavior is built using a first set of historical logs;
using data from the expected traffic behavior, generate a forecasted traffic for the event of the first application for a plurality of periods of time in future;
determine a difference between the monitored traffic and the forecasted traffic of the event of the first application; and
flag the event of the first application as an anomalous dip when the difference is below a threshold;
a correlator configured to:
check whether the first application is related to a second application based on the anomalous dip detected in the traffic related to the first application;
traffic patterns from the first application and the second application when the first application is related to the second application; and
cause the machine learning module to predict an anomalous dip for the second application; and
an alert generator to notify the tenant about a flag for remediation, wherein traffic at the app connector is split into a plurality of timeframes to reduce time for detection of the anomalous dip.

2. The data exfiltration protection system of claim 1, wherein the anomalous dip is a result of failure in the app connector.

3. The data exfiltration protection system of claim 1, wherein the flag for remediation is done when the anomalous dip triggers a policy for an end-user device of the plurality of end-user devices.

4. The data exfiltration protection system of claim 1, wherein the machine learning module uses a plurality of variables for training, the plurality of variables for training the machine learning module comprises:
a holiday flag that uses holidays of a calendar to make a forecast; and
a lag magnitude that takes a second set of historical logs of a plurality of events of a plurality of applications.

5. The data exfiltration protection system of claim 1, wherein the machine learning module is retrained periodically in 28 days.

6. The data exfiltration protection system of claim 1, wherein traffic from the first application is correlated with traffic from the second application, for a plurality of applications that are interrelated to detect a similar anomaly.

7. (canceled)

8. A data exfiltration protection method that uses machine learning to analyze traffic between a plurality of end-user devices and a plurality of vendors, the data exfiltration protection method comprises:
transmitting traffic between the plurality of end-user devices and the plurality of vendors at an application layer of a cloud network;
using a machine learning module to identify an event of a first application at an app connector, the machine learning module is operable to:
monitoring traffic for the event of the first application at the app connector for a period of time;
generating an expected traffic behavior for the event of the first_application, wherein the expected traffic behavior is built using a first set of historical logs;
generating, using data from the expected traffic behavior, a forecasted traffic for the event of the first application for a plurality of periods of time in future;
determining a difference between the monitored traffic and the forecasted traffic of the event of the first application;
flagging the event of the first application as an anomalous dip when the difference is below a threshold, wherein the anomalous dip is a result of failure in the app connector;
checking whether the first application is related to a second application based on the anomalous dip detected in the traffic related to the first application;
matching traffic patterns from the first application and the second application when the first application is related to the second application; and
causing the machine learning module to predict an anomalous dip for the second application; and
generating an alert to notify a tenant about a flag for remediation.

9. (canceled)

10. The data exfiltration protection method of claim 8, wherein the flag for remediation is done when the anomalous dip triggers a policy for an end-user device of the plurality of end-user devices.

11. The data exfiltration protection method of claim 8, wherein the machine learning module uses a plurality of variables for training. The plurality of variables for training the machine learning module comprises:
a holiday flag that uses holidays of a calendar to make a forecast; and
a lag magnitude that takes a second set of historical logs of a plurality of events of a plurality of applications.

12. The data exfiltration protection method of claim 8, wherein the machine learning module is retrained periodically in 28 days.

13. The data exfiltration protection method of claim 8, wherein traffic from the first application is correlated with traffic from the second application, for a plurality of applications that are interrelated, to detect a similar anomaly.

14. The data exfiltration protection method of claim 8, wherein traffic at the app connector is split into a plurality of timeframes to reduce time for detection of the anomalous dip.

15. A non-transitory computer-readable media having computer-executable instructions embodied thereon that, when executed by one or more processors, facilitate a data exfiltration protection method that uses machine learning to analyze traffic between a plurality of end-user devices and a plurality of vendors, the data exfiltration protection method comprises:
transmitting traffic between the plurality of end-user devices and the plurality of vendors at an application layer of a cloud network;
using a machine learning module comprising one or more processors configured to identify an event of a first application at an app connector, the machine learning module is operable to:
monitoring traffic for the event of the first application at the app connector for a period of time;
generating an expected traffic behavior for the event of the first_application, wherein the expected traffic behavior is built using a first set of historical logs;
generating, using data from the expected traffic behavior, a forecasted traffic for the event of the first application for a plurality of periods of time in future;
determining a difference between the monitored traffic and the forecasted traffic of the event of the first application;
flagging the event of the first application as an anomalous dip when the difference is below a threshold, wherein the anomalous dip is a result of failure in the app connector;
checking whether the first application is related to a second application based on the anomalous dip detected in the traffic related to the first application;
matching traffic patterns from the first application and the second application when the first application is related to the second application; and
causing the machine learning module to predict an anomalous dip for the second application; and
generating an alert to notify a tenant about a flag for remediation.

16. (canceled)

17. The non-transitory computer-readable media of claim 15, wherein the flag for remediation is done when the anomalous dip triggers a policy for an end-user device of the plurality of end-user devices.

18. The non-transitory computer-readable media of claim 15, wherein the machine learning module is retrained periodically in 28 days.

19. The non-transitory computer-readable media of claim 15, wherein the machine learning module uses a plurality of variables for training. The plurality of variables for training the machine learning module comprises:
a holiday flag that uses holidays of a calendar to make a forecast; and
a lag magnitude that takes a second set of historical logs of a plurality of events of a plurality of applications.

20. The non-transitory computer-readable media of claim 15, wherein traffic from the first application is with traffic from the second application, for a plurality of applications that are interrelated, to detect a similar anomaly.
